(19) United States
(12) Patent Application Publication
(10) Pub. No.: US 2012/0063902 A1
(43) Pub. Date: Mar. 15, 2012

(54) ENERGY GENERATION PLANT, IN PARTICULAR WIND POWER PLANT

(76) Inventor: Gerald Heenberger, Klagenfurt (AT)

(21) Appl. No.: 13/322,258

(22) PCT Filed: May 25, 2010
(86) PCT No.: PCT/AT2010/000182

§ 371 Date: Nov. 23, 2011

(30) Foreign Application Priority Data
May 25, 2009 (AT) A 805/2009

(51) Int. Cl. F03D 11/02

(52) U.S. Cl. 416/170 R

(57) ABSTRACT

An energy generation plant, in particular a wind power plant, has a drive shaft, a generator (8), and a differential gear (11 to 13) with three drives and outputs. A first drive is connected to the drive shaft, one output to a generator (8), and a second drive is connected to a differential drive (6). The differential gear (11 to 13) is arranged on one side of the generator (8), and the differential drive (6) is arranged on the other side of the generator. The differential gear (11 to 13) is connected to the differential drive (6) via a shaft (16) that runs through the generator (8). The differential gear is a helical gear, and a bearing (19) absorbing axial forces is arranged in the region of an end of the generator that is on the differential gear side, and the bearing absorbs the axial forces of the second output.

The invention relates to an energy generation plant, in particular a wind power plant, with a drive shaft, a generator, and with a differential gear with three drives and outputs, whereby a first drive is connected to the drive shaft, one output to a generator, and a second drive is connected to a differential drive, whereby the differential drive is arranged on one side of the generator and the differential drive is arranged on the other side of the generator, and whereby the differential gear is connected to the differential drive by means of a shaft that runs through the generator.

Such an energy generation plant is known from WO 00/17543 A1.

Wind power plants are becoming increasingly important as electricity-generating plants. For this reason, the percentage of power generation by wind is continuously increasing. This in turn dictates, on the one hand, new standards with respect to current quality, and, on the other hand, a trend toward still larger wind power plants. At the same time, a trend is recognizable toward offshore wind power plants, which trend requires plant sizes of at least 5 MW installed power. Due to the high costs for infrastructure and maintenance and/or repair of wind power plants in the offshore region, here, both efficiency and also production costs of the plants with the associated use of medium-voltage synchronous generators acquire special importance.

WO2004/109157 A1 shows a complex, hydrostatic “multi-path” concept with several parallel differential stages and several switchable clutches, as a result of which it is possible to switch between the individual paths. With the technical approach shown, the power and thus the losses of the hydrostatics can be reduced. One major disadvantage is, however, the complicated structure of the entire unit.

EP 1283359 A1 shows a 1-stage and a multi-stage differential gear with an electrical differential drive, whereby the 1-stage version has a special three-phase a.c. machine with high nominal rpm that is positioned coaxially around the input shaft and that—based on the design—has an extremely high mass moment of inertia relative to the rotor shaft. As an alternative, a multi-stage differential gear with a high-speed standard three-phase a.c. machine is proposed, which is oriented parallel to the input shaft of the differential gear.

These technical approaches do allow the direct connection of medium-voltage synchronous generators to the network (i.e., without the use of frequency converters); the disadvantages of known embodiments are, however, on the one hand, high losses in the differential drive and/or, on the other hand, in designs that solve this problem, complex mechanics or special electrical-machine technology, and thus high costs. In general, it can be determined that cost-relevant criteria, such as, e.g., optimal integration of the differential stage in the drive train of the wind power plant, were not adequately taken into consideration.

The object of the invention is to avoid the aforementioned disadvantages as much as possible and to make available a differential drive, which in addition to low costs also ensures good integration in the drive train of the wind power plant.

This object is achieved according to the invention in that the differential gear is a helical gear and in that a bearing absorbing axial forces is arranged in the region of a differential-gear-side end of the generator, which bearing absorbs the axial forces of the second output.

As a result, a very compact and efficient design of the plant is possible, with which, moreover, also no significant additional loads are produced for the generator of the energy generation plant, in particular a wind power plant.

Preferred embodiments of the invention are the subject of the subclaims.

Below, preferred embodiments of the invention are described in detail with reference to the attached drawings.

FIG. 1 shows the principle of a differential gear with an electrical differential drive according to the state of the art.

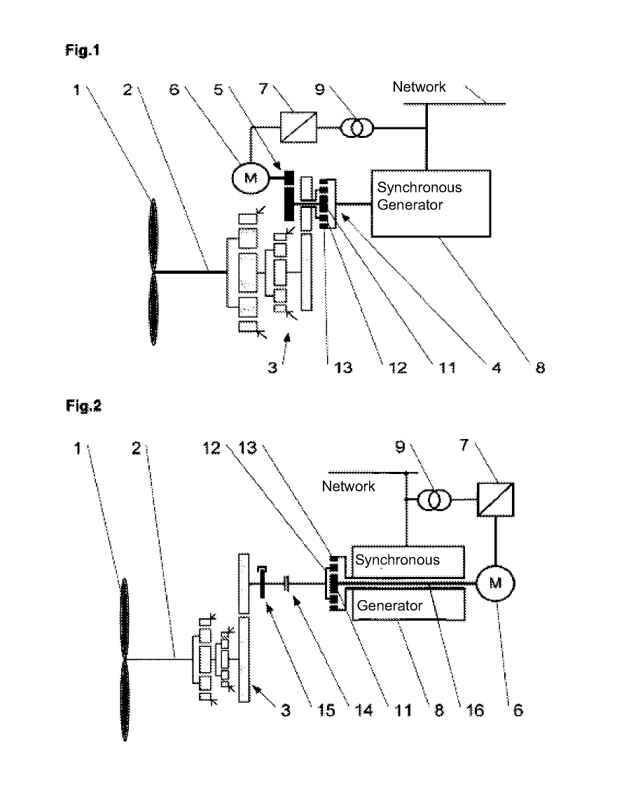

FIG. 2 shows an embodiment, according to the invention, of a differential stage in connection with this invention.

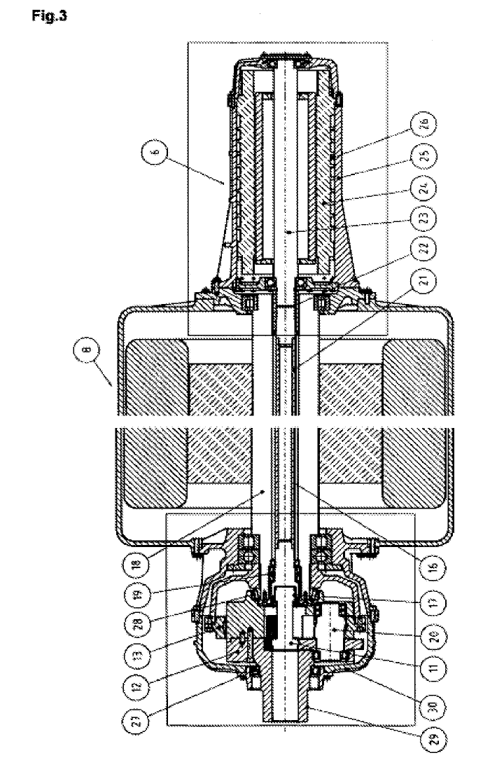

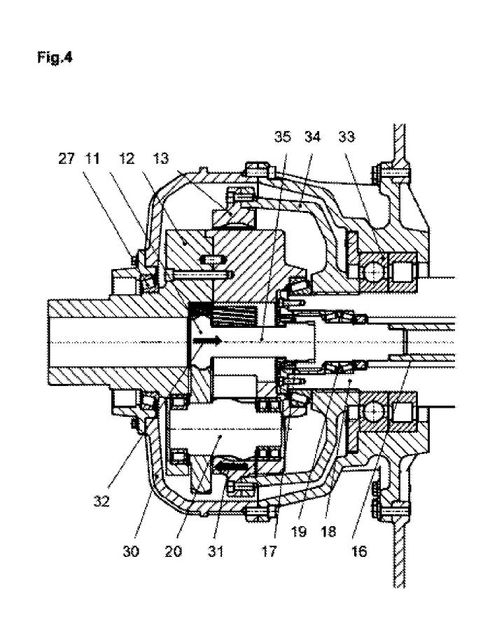

FIG. 3 shows an embodiment, according to the invention, of a drive train with a differential drive with a stepped planet.

FIG. 4 shows the disposition of the shaft in the region of the front or gear-side disposition of the generator of FIG. 3 on an enlarged scale.

The output of the rotor of a wind power plant is calculated from the formula:

Rotor Output=Rotor Area*Output Coefficient*Wind Speed³*Air Density/2

whereby the output coefficient is dependent on the high speed number (=ratio of blade tip speed to wind speed) of the rotor of the wind power plant. The rotor of a wind power plant is designed for an optimum output coefficient based on a high speed number that is to be established in the course of development (in most cases, a value of between 7 and 9). For this reason, in the operation of the wind power plant in the partial load range, a correspondingly low speed can be set to ensure optimum aerodynamic efficiency.

FIG. 1 shows a possible principle of a differential system for a wind power plant that consists of differential stage(s) 4 and/or 11 to 13, an adaptive reduction stage 5, and an electrical differential drive 6. The rotor 1 of the wind power plant, which sits on the drive shaft 2 for the main gearbox 3, drives the main gearbox 3. The main gearbox 3 is a 3-stage gearbox with two planetary stages and a spur-wheel stage. Between the main gearbox 3 and the generator 8, there is the differential stage 4, which is driven by the main gearbox 3 via planetary carriers 12 of the differential stage 4. The generator 8—preferably a separately excited mean voltage synchronous generator—is connected to the hollow wheel 13 of the differential stage 4 and is driven by the latter. The pinion gear 11 of the differential stage 4 is connected to the differential drive 6. The speed of the differential drive 6 is regulated, on the one hand, to ensure, in the case of the variable speed of the rotor 1, a constant speed of the generator 8, and, on the other hand, to regulate the torque in the complete drive train of the wind power plant. In the case shown, to increase the input speed for the differential drive 6, a 2-stage differential gear is selected, which provides an adaptive reduction stage 5 in the form of a front-wheel stage between the differential stage 4 and the differential drive 6. The differential stage 4 and the adaptive reduction stage 5 thus form the 2-stage differential gear. The differential drive is a three-phase a.c. machine, which is connected to the network via a frequency converter 7 and a transformer 9. As an alternative, the differential drive can also be designed as, e.g., a hydrostatic pump/motor combination. In this case, the second pump is preferably connected via an adaptive reduction stage to the drive shaft of the generator 8.

The speed equation for the differential gear reads:

Speed_{Generator}=x*Speed_{Rotor}+y*Speed_{Differential Drive},

whereby the generator speed is constant, and the factors x and y can be derived from the selected gear ratios of the main gearbox and the differential gearbox.

The torque on the rotor is determined by the available wind supply and the aerodynamic efficiency of the rotor. The ratio between the torque at the rotor shaft and that on the differential drive is constant, by which the torque in the drive train can be regulated by the differential drive. The equation of the torque for the differential drive reads:

Torque_{Differential Drive}=Torque_{Rotor}*y/x,

whereby the size factor y/x is a measurement of the required design torque of the differential drive.

The output of the differential drive is essentially proportional to the product that consists of the percentage deviation of the rotor speed from its basic speed times rotor output. Consequently, a large speed range in principle requires a correspondingly large sizing of the differential drive.

FIG. 2 shows an embodiment according to the invention of a one-stage differential gear 11 to 13. The rotor 1, which sits on the drive shaft 2 for the main gearbox 3, drives the main gearbox 3, and the differential gears 11 to 13 drive the latter via planetary carriers 12. The generator 8 is connected to the hollow wheel 13 of the differential gear, and the pinion 11 is connected by means of a shaft 16 to the differential drive 6. The differential drive 6 is a three-phase a.c. machine that is connected to the network via the frequency converter 7 and the transformer 9. The differential drive 6 is in a coaxial arrangement both on the drive shaft of the main gearbox 3 and on the drive shaft of the generator 8. The drive shaft of the generator 8 is a hollow shaft, which allows the differential drive 6 to be positioned on the side of the generator 8 that faces away from the differential gear 11 to 13 and is connected by means of a shaft 16. As a result, the differential gear 11 to 13 is preferably a separate assembly that is connected to the generator 8, which then preferably is connected via a coupling 14 and a brake 15 to the main gearbox 3. The shaft 16 that is mounted in the differential drive 6 can be designed as, e.g., a steel shaft.

Significant advantages of the coaxial 1-stage embodiment shown are (a) the simplicity of the design and the compactness of the differential gear 11 to 13, (b) the thus high degree of efficiency of the differential gear, and (c) the optimal integration of the differential gear in the drive train of the wind power plant.

Moreover, the differential gear 11 to 13 can be fabricated as a separate assembly and implemented and maintained independently from the main gearbox. Of course, the differential drive 6 can also be replaced here by a hydrostatic drive, but to do this, a second pump element interacting with the hydrostatic differential drive has to be driven preferably by the gear-output shaft connected to the generator 8.

FIG. 3 shows an embodiment of a drive train with a differential gear 11 to 13 with stepped planets 20. As already in FIG. 2, the differential drive 6 is also driven here by the pinion gear 11 via a shaft 16. The pinion gear 11 is preferably connected to the shaft 16 by means of a splined shaft connection 17. The shaft 16 is mounted in one place by means of a bearing 19 in the region of the gear-side end, the so-called D-end below, of the generator 8 in the generator hollow shaft 18. Alternatively, the shaft 16 can also be mounted in multiple places in, e.g., the generator shaft.

Preferably, the shaft 16 essentially consists of a hollow shaft 21 and the splined shaft connections 17 and 22, which are connected to the hollow shaft 21. The hollow shaft 21 is preferably a pipe made of steel, or is in an especially rigid design or in a design with a low mass moment of inertia that consists of fiber composite material with, e.g., carbon or glass fibers.

The differential drive 6 is fastened on the differential drive-side end, the so-called ND end below, of the generator 8. This differential drive 6 is preferably a permanent-magnet-activated synchronous machine with a rotor 23 with a low mass moment of inertia, a stator 24 with integrated channels 26 arranged in the peripheral direction for the water jacket cooling and a housing 25. These channels 26 can alternatively also be integrated in the housing 25 or both in the stator 24 and in the housing 25. The shaft end of the rotor 23 is the counterpart to the splined shaft connection 22. Thus, this shaft end of the shaft 16 is mounted via the rotor 23. Alternatively, this shaft end of the shaft 16 can also be mounted in the generator hollow shaft 18.

The rotor shaft 18 of the generator 8 is driven by the hollow wheel 13. The planets that are preferably mounted in two places—in the example shown three in number—are so-called stepped planets 20 in the planetary carrier 12, which is designed in two parts in the embodiment of FIG. 3. The latter consist in each case of two rotation-resistant gears that are connected to one another with different reference diameters and preferably different gear geometry. In the example that is shown, the hollow wheel 13 is engaged with the gear of the stepped planet 20 that is smaller in diameter, and the pinion gear 11 is engaged with the second gear of the stepped planet 20. Since significantly higher torques have to be transferred via the hollow wheel 13 than via the pinion gear 11, the tooth width for the latter is significantly larger than that for the pinion gear 11. For the sake of noise reduction, the gearing of the differential gear is designed as a helical gear. Preferably, the individual angles of inclination of the gear parts of the stepped planet are selected in such a way that no resulting axial force acts on the disposition of the stepped planet. Based on the orientation of the helical gear, the shaft 16 is either loaded under tension or under pressure in normal operation. In various special load cases, the direction of the axial force temporarily rotates.

In the example that is shown, the multi-part planetary carrier 12 is also mounted in two places by means of bearings 27, 28 to be able to better draw off the forces that develop on the shaft end 29 in the gear housing 30. Alternatively here, a so-called planetary carrier that is mounted on one side can also be used that has only one adequately sized disposition in the region of the bearing 27, in which case the disposition in the region of the bearing 28 becomes unnecessary.

FIG. 4 shows in detail a variant embodiment of the disposition of the shaft 16 in the region of the gear-side disposition of the generator. The helical gear-like differential gear is mounted as already described in FIG. 3 and consists of a hollow wheel 13, a two-part planetary carrier 12, a stepped planet 20, and a pinion gear 11. By the helical gear, an axial force 31 is produced on the hollow wheel 13, and an axial force 32 oriented in the opposite direction to the latter is produced on the pinion gear 11. These axial forces 31, 32 have an order of magnitude of respectively about 12 kN for the differential drive of a 3MW wind power plant in nominal operation. To prevent the axial force compensation of the pinion gear 11 from acting on the generator shaft 18 with the hollow wheel carrier 34 and the hollow wheel 13 via the shaft 16, the differential drive 6, the housing of the generator 8, and the generator bearing 33, the bearing 19 is designed as a so-called fixed bearing, which takes up all axial forces acting on the shaft 16 and funnels them directly into the generator shaft 18. So as not to limit the radial freedom of motion of the pinion gear 11, the pinion gear shaft 35 is connected to the shaft 16 by means of the axially secured splined shaft connection 17.

With this technical solution, three essential advantages are achieved. These are: (a) the long, fast-rotating shaft 16 is free of axial forces 32, (b) the pinion gear 11 can freely adjust radially, and (c) the disposition of the generator 8 can also be designed free of axial forces 31 or 32, since the axial forces now act directly on the bearing 19, generator shaft 18, and hollow wheel carrier 34.

For the sake of completeness, it can be mentioned here that the above-mentioned advantages also apply for a differential stage with simple planets—i.e., no stepped planets.

1. Energy generation plant, in particular a wind power plant, with a drive shaft, a generator (8), and with a differential gear (11 to 13) with three drives and outputs, whereby a first drive is connected to the drive shaft, one output to a generator (8), and a second drive is connected to a differential drive (6), whereby the differential gear (11 to 13) is arranged on one side of the generator (8) and the differential drive (6) is arranged on the other side of the generator, and whereby the differential gear (11 to 13) is connected to the differential drive (6) by means of a shaft (16) that runs through the generator (8), characterized in that the differential gear (11 to 13) is a helical gear and in that a bearing (19) absorbing axial forces is arranged in the region of an end of the generator (8) that is on the differential gear side, and said bearing absorbs the axial forces of the second output.

2. Energy generation plant according to claim 1, wherein the bearing (19) is a fixed bearing.

3. Energy generation plant according to claim 1, wherein the bearing (19) is arranged on a generator shaft (18).

4. Energy generation plant according to claim 1, wherein the shaft (16) is mounted by means of the bearing (19).

5. Energy generation plant according to claim 1, wherein the differential gear (11 to 13) is a planetary gear.

6. Energy generation plant according to claim 5, wherein planetary wheels (20) of the planetary gear (4) in each case have two gears, which are connected to one another in a torque-proof manner and have different reference diameters.

7. Energy generation plant according to claim 6, wherein the two gears have gearing with different tilting of the splines.

8. Energy generation plant according to claim 5, wherein the second output is a pinion gear shaft (35) of the planetary gear (4), which is connected to the shaft (16) by means of a splined shaft connection (17).

9. Energy generation plant according to claim 5, wherein a hollow wheel (13) of the planetary gear (4) is connected tightly to the generator shaft (18).

10. Energy generation plant according to claim 1, wherein the shaft (16) is mounted via a splined shaft connection (22) in the rotor (23) of the differential drive (6).

11. Energy generation plant according to claim 1, wherein the shaft (16) is mounted in the differential-drive-side end of the generator shaft (18).

12. Energy generation plant according to claim 1, wherein the shaft (16) has a hollow shaft (21).

13. Energy generation plant according to claim 12, wherein the hollow shaft (21) is a fiber-composite shaft.

14. Energy generation plant according to claim 1, wherein the differential drive (6) is arranged coaxially to the shaft of the generator (8).

15. Energy generation plant according to claim 1, wherein the drive shaft is the rotor shaft (2) of a wind power plant.

16. Energy generation plant according to claim 1, wherein the differential drive (6) is an electrical machine.

17. Energy generation plant according to claim 16, wherein the electrical machine is a permanent-magnet-activated synchronous machine.

18. Energy generation plant according to claim 1, wherein the differential drive (6) is a hydraulic drive, in particular a hydrostatic drive.

19. Energy generation plant according to claim 2, wherein the bearing (19) is arranged on a generator shaft (18).
